(19) United States
(12) Patent Application Publication
(10) Pub. No.: US 2016/0101742 A1
(43) Pub. Date: Apr. 14, 2016

(54) SYSTEM FOR ATTACHING A WINDOW ORNAMENT TO A VEHICLE

(71) Applicant: Matthew Martin Mershon, Terre Haute, IN (US)

(72) Inventor: Matthew Martin Mershon, Terre Haute, IN (US)

(21) Appl. No.: 14/827,355

(22) Filed: Aug. 17, 2015

Related U.S. Application Data
(60) Provisional application No. 62/062,390, filed on Oct. 10, 2014.

(51) Int. Cl. B60R 13/00; B60R 11/00

(52) U.S. Cl. CPC B60R 13/00; B60R 11/00; B60R 2011/0026; B60R 2011/0085; B60R 2011/0057; B60R 2011/0056

(57) ABSTRACT

A system for attaching a window ornament to a vehicle is provided. The system includes a vehicle attachment device having a mounting device constructed and arranged to attach to the vehicle; and an arm operably coupled to the mounting device. The arm is rotatable with respect to the mounting device. The system also includes an ornament attachment device operably coupled to the vehicle attachment device and being constructed and arranged to couple to a window ornament.

### CROSS REFERENCE TO RELATED APPLICATIONS

The is application claims priority to and is a non-provisional of U.S. Provisional Patent Application Ser. No. 62/062,390, filed Oct. 10, 2014 and titled “SYSTEM FOR ATTACHING A WINDOW ORNAMENT TO A VEHICLE,” which is herein incorporated by reference in its entirety.

### TECHNICAL FIELD OF THE DISCLOSED EMBODIMENTS

The present disclosure is generally related to window ornaments for vehicles, and, more particularly, to a system for attaching a window ornament to a vehicle.

### BACKGROUND OF THE DISCLOSED EMBODIMENTS

Generally, automotive accessories, such as window ornaments, include devices to suspend the ornament above the roofline of the vehicle. Generally, these ornament attaching devices may attach an ornament directly to the roof or to the vehicle's window such that the ornament is not visible by the occupants within the vehicle. There is therefore a need for a system to attach a window ornament to a vehicle and have it visible to the occupants therein.

### SUMMARY OF THE DISCLOSED EMBODIMENTS

In one aspect, a system for attaching a window ornament to a vehicle is provided. The system includes a vehicle attachment device having a mounting device constructed and arranged to attach to the vehicle; and an arm operably coupled to the mounting device. The arm is rotatable with respect to the mounting device. The system also includes an ornament attachment device operably coupled to the vehicle attachment device and being constructed and arranged to couple to a window ornament.

In another aspect, a system for attaching a window ornament to a vehicle is provided. The system includes a vehicle attachment device having a mounting device constructed and arranged to attach to an edge of a window. An arm is operably coupled to the mounting device. The arm includes a proximal end and a distal end. The distal end is coupled to the mounting device. The proximal end is positioned below a point on the edge of the window where the mounting device is attached. The system also includes an ornament attachment device operably coupled to the vehicle attachment device and being constructed and arranged to couple to a window ornament.

In another aspect, a system for attaching a window ornament to a vehicle is provided. The system includes a vehicle attachment device having a mounting device constructed and arranged to attach to the vehicle. The mounting device defines a mounting device axis. An arm is operably coupled to the mounting device. The arm defines an arm axis. The arm axis is positioned at an angle of less than or equal to 135 degrees with respect to the mounting device axis. The system also includes an ornament attachment device operably coupled to the vehicle attachment device and being constructed and arranged to couple to a window ornament.

### BRIEF DESCRIPTION OF THE DRAWINGS

The embodiments and other features, advantages, and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a perspective view of a system for attaching a window ornament to a vehicle according to at least one embodiment of the present disclosure;

FIG. 2 is a perspective view of an embodiment of a vehicle attachment device according to the present disclosure;

FIG. 3 is a perspective view of another embodiment of a vehicle attachment device according to the present disclosure;

FIG. 4 is a perspective view of at least one embodiment of an arm of the vehicle attachment device according to the present disclosure;

FIG. 5 is a perspective view of an embodiment of the ornament attachment device according to the present disclosure; and

FIG. 6 is a perspective view of an embodiment of the system for attaching a window ornament to a vehicle according to at least one embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

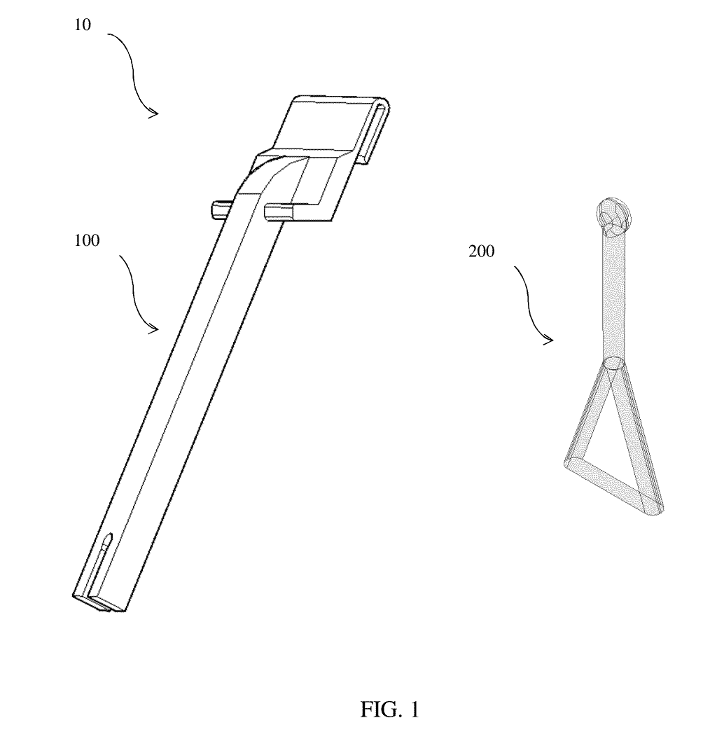

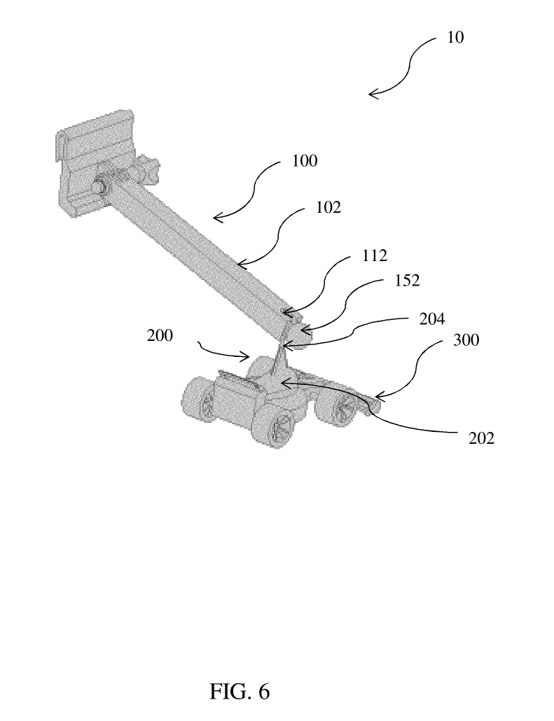

FIG. 1 illustrates an embodiment of a system, generally indicated at 10, for attaching a window ornament to a vehicle (see FIG. 6). The system 10 includes a vehicle attachment device 100 and an ornament attachment device 200, wherein the ornament attachment device 200 is configured to engage the vehicle attachment device 100. It will be appreciated that the vehicle attachment device 100, and the ornament attachment device 200 may be composed of any durable materials, including but not limited to, hard plastic, soft plastic, metal, foam, flexible material, and non-flexible material.

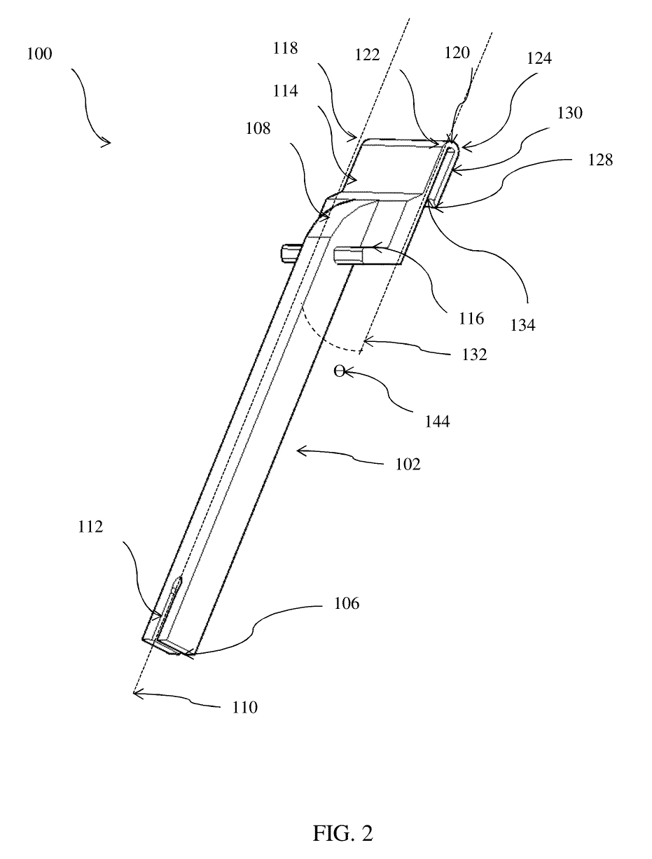

FIG. 2 illustrates one embodiment of the vehicle attachment device 100. The vehicle attachment device 100 is configured to engage the ornament attachment device 200 (later described herein), and attach to a portion of a vehicle. The vehicle attachment device 100 includes an arm 102 operably coupled to a mounting device 104. It will be appreciated that the arm 102 and the mounting device 104 may be integrally formed from one piece of material such that the arm 102 extends from the mounting device 104. Although the mounting device 104 illustrated herein is adapted to be coupled to an edge of a window of the vehicle, it will also be appreciated that the mounting device 104 may include any suitable device capable of being attached to a vehicle (e.g. magnet, suction cup, cavity, etc. to name a few non-limiting examples).

In one embodiment, the arm 102 includes an arm proximal end 106, an arm distal end 108, and an arm longitudinal axis 110, wherein the arm distal end 108 is operably coupled to the mounting device 104. The arm 102 further includes an ornament retention portion 112. The ornament retention portion 112 is configured to engage a portion of the ornament attachment device 200. In one embodiment, the ornament retention portion 112 includes a slot, wherein the slot extends from the arm proximal end 106 towards the arm distal end 108 and is substantially parallel to the arm longitudinal axis 110.

In one embodiment, the mounting device 104 includes a first surface 114, including a first surface proximal end 116 and a first surface distal end 118; a curved portion 120, including a first curved end 122 and a second curved end 124; a second surface 126, including a second surface proximal end 128 and a second surface distal end 130; and a mounting device axis 132, wherein the first surface 114 and the second surface 126 are operably coupled to the curved portion 120 to form a cavity 134 between the first surface 114 and the second surface 126. In one embodiment, the cavity 134 is constructed and arranged to receive an edge of a vehicle window in order to mount the mounting device to the vehicle window and hence to the vehicle.

The first surface distal end 118 is operably coupled to the first curved end 122, and the second surface distal end 130 is operably coupled to the second curved end 124. It will be appreciated that the first surface 114, curved portion 120 and second surface 126 may be formed from one continuous piece of material such that there is no material discontinuity between the first surface distal end 118 and the first curved end 122, or between the second surface distal end 130 and the second curved end 124. It will be appreciated that in the embodiment of the vehicle attachment device 100, shown in FIG. 2, the arm 102 and the mounting device 104 are integrally formed from one piece of material such that there is no material discontinuity between the arm distal end 108 and the first surface proximal end 116, and that arm longitudinal axis 110 is substantially parallel to the mounting device axis 132.

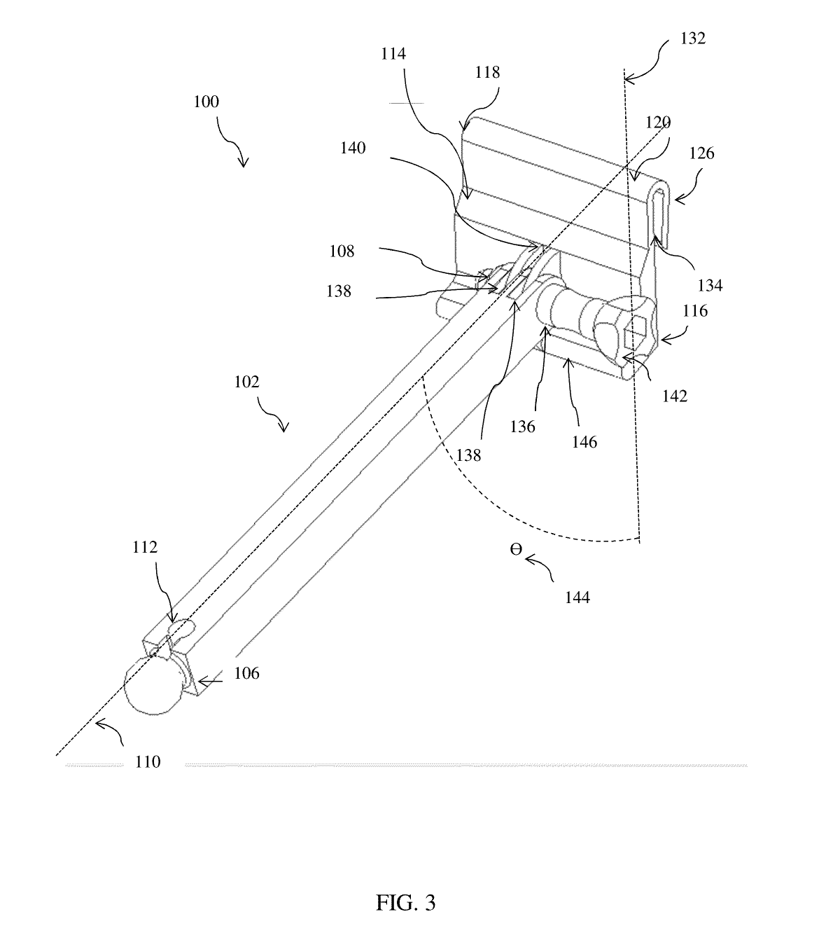

FIG. 3 illustrates another embodiment of the vehicle attachment device 100. In the embodiment shown, the arm distal end 108 includes at least one arm aperture 136 disposed therethrough. In one embodiment, the at least one arm aperture 136 extends substantially perpendicular to the arm longitudinal axis 110. In one embodiment, the arm distal end 108 further includes at least one mounting slot 138 disposed therethrough. In one embodiment, the at least one mounting slot 138 extends substantially perpendicular to the arm longitudinal axis 110 and to the at least one arm aperture 136.

In one embodiment, the mounting device 104 includes at least one mounting tab 140 disposed thereon. In one embodiment, the at least one mounting tab 140 is disposed on the first surface 114. In one embodiment, the at least one mounting tab 140 includes at least one tab aperture (not shown) disposed therethrough.

The at least one mounting slot 138 is configured to be aligned with a respective one of the at least one mounting tab 140 such that the arm aperture 136 is aligned with the at least one tab aperture (not shown) in order to receive a retention device 142, for example, a pin to name one non-limiting example. Once the retention device 142 is inserted through the arm aperture 136 and the at least one tab aperture (not shown), the arm 102 may be rotated to an angle 144 less than or equal to approximately 180 degrees to the mounting device axis 132. In one embodiment, the arm 102 may be rotated to any angle with respect to the mounting device axis 132. In one embodiment, the arm longitudinal axis 110 is positioned less than or equal to 135 degrees with respect to the mounting device axis 132. In one embodiment, the first surface 114 includes a lip 146 disposed at or near the first surface proximal end 116, wherein the lip 146 is substantially perpendicular to the mounting device axis 132. The lip 146 is configured to prevent the arm 102 from rotating to an angle 144 less than 90 degrees to the mounting device axis 132. In other embodiments, the lip 146 may prevent the arm 102 from rotating to an angle 144 less than another predetermined number of degrees to the mounting device axis 132.

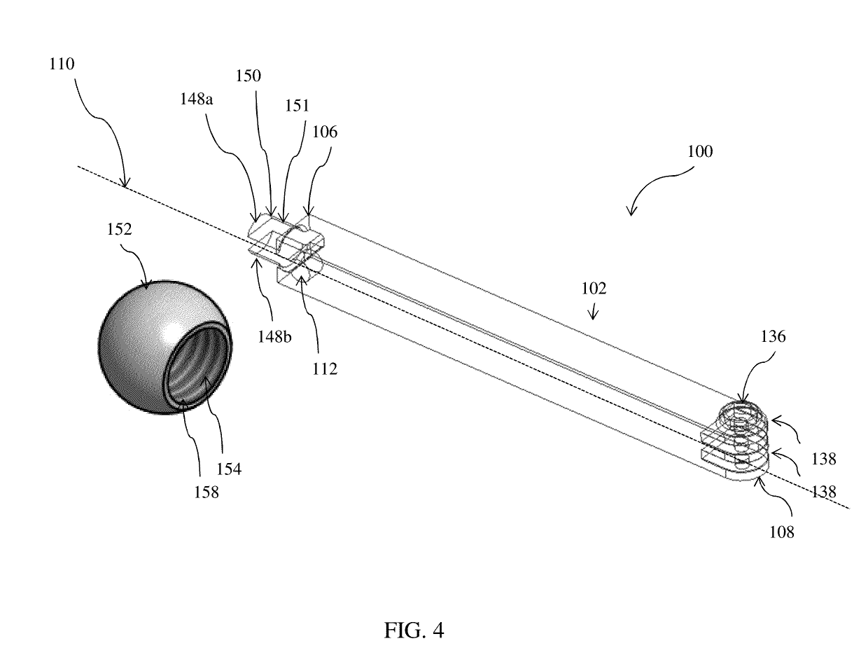

FIG. 4 illustrates another embodiment of the arm 102. In the embodiment shown, the arm proximal end 106 further includes a proximal end post 148, including a post outer surface 150, disposed thereon, wherein the proximal end post 148 extends substantially parallel to the arm longitudinal axis 110. The proximal end post 148 further includes the ornament retention portion 112, wherein the ornament retention portion extends through at least a portion of the proximal end post 148 creating a first proximal post portion 148a and a second proximal post portion 148b; and wherein the ornament retention portion 112 extends substantially parallel to the arm longitudinal axis 110. In one embodiment, the post outer surface 150 includes a plurality of threads 151 disposed thereon. The arm proximal end 106 further includes a removable retention knob 152. The removable retention knob 152 includes a knob cavity 154 including a cavity peripheral wall 156. In one embodiment, the cavity peripheral wall 156 includes a plurality of threads 158 disposed thereon. The proximal end post 148 is configured to be inserted into the knob cavity 154, and in certain embodiments, the removable retention knob 152 may be secured to the proximal end post 148 by turning the removable retention knob 152 such that the plurality of threads 158 on the cavity peripheral wall 156 engage the plurality of threads 151 on the post outer surface 150.

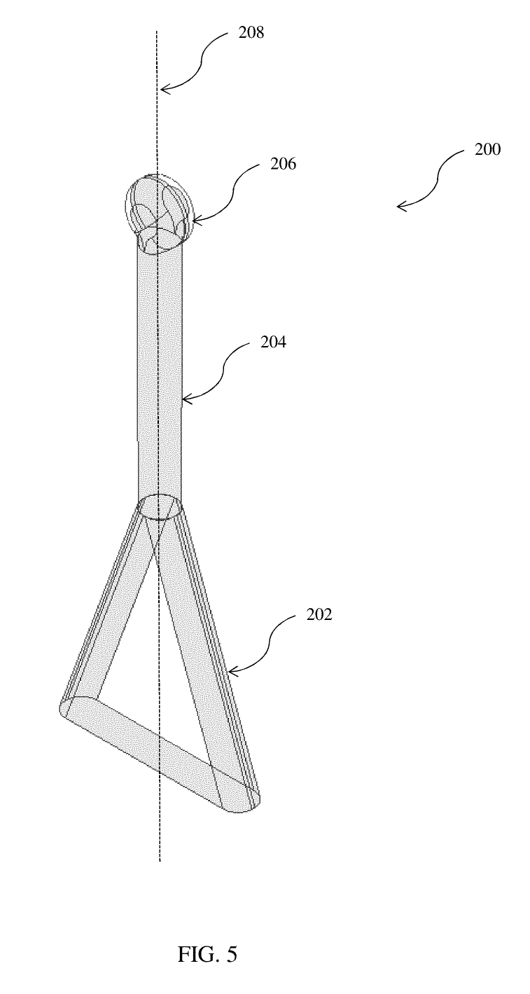

FIG. 5 illustrates an embodiment of the ornament attachment device 200. The ornament attachment device 200 includes a base 202, an extension rod 204 operably coupled to the base 202, an attachment knob 206 operably coupled to the extension rod 204, and an attachment device axis 208. In one embodiment, the attachment knob 206 includes a knob aperture 205 disposed therethrough. It will be appreciated that the ornament attachment device 200 may be integrally formed from one piece of material such that there is no material discontinuity between the extension rod 204 and the base 202, or between the attachment knob 206 and the extension rod 204.

In one embodiment, at least a portion of the base 202 is positioned substantially perpendicular to attachment device axis 208. It will be appreciated that while the base 202 is shown with a triangular geometry, the base 202 may be formed in any geometrical shape. The extension rod 204 is operably coupled to the base 202 such that the extension rod 204 is substantially parallel to the attachment device axis 208.

FIG. 6 illustrates an embodiment of the system 10 in use. As shown, an ornament 300 is operably coupled to the ornament attachment device 200. For example, the portion of the base 202 that is substantially perpendicular to the attachment device axis 208 may be affixed to a portion of the ornament 300. It will be appreciated that the ornament 300 may be affixed to the base 202 by any suitable means, for example, adhesive or a fastener to name a couple of non-limiting examples. A portion of the extension rod 204 and the attachment knob 206 are inserted into the ornament retention portion 112, and the removable retention knob 152 is secured to the proximal end post 148 of the arm 102, thus preventing the extension rod 204 from sliding out of the ornament retention portion 112. Once the removable retention knob 152 is secured to the proximal end post 148 of the arm 102, the mounting device 100 may be secured to the vehicle (e.g. an edge of a vehicle window). The vehicle's window may be inserted within the cavity 134. The vehicle's window may then be placed in a closed position to prevent the mounting device 104 from becoming disengaged from the window. It will be appreciated that the mounting device 104 may provide enough tension within the cavity 134 to allow the vehicle's window to be placed at a level higher than fully open, but less than fully closed. Once the mounting device 104 is secured to the vehicle's window, the arm 102 may be positioned at an angle 144 less than or equal to approximately 180 degrees such that the ornament 300 may be visible by the passengers within the vehicle. In one embodiment, the arm longitudinal axis 110 is positioned with respect to the mounting device axis 132 so that the arm proximal end 106 is positioned below a point on the edge of the window where the mounting device 100 is attached.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for attaching a window ornament to a vehicle comprising:
a vehicle attachment device comprising:
a mounting device constructed and arranged to attach to the vehicle; and
an arm operably coupled to the mounting device, the arm being rotatable with respect to the mounting device; and
an ornament attachment device operably coupled to the vehicle attachment device and being constructed and arranged to couple to a window ornament.

2. The system of claim 1, wherein the ornament attachment device further comprises:
an attachment end constructed and arranged to attach to the arm of the vehicle attachment device; and
an extension rod extending from the attachment end, the extension rod constructed and arranged to couple to the window ornament

3. The system of claim 1, wherein the arm further comprises a slot and the attachment end is disposed in the slot.

4. The system of claim 3 further comprising a retention knob constructed and arranged to secure the attachment end in the slot.

5. The system of claim 3, wherein the arm includes a proximal end and a distal end, the distal end is coupled to the mounting device, and the slot positioned at the proximal end.

6. The system of claim 1, wherein the mounting device comprises at least one of a magnet, a suction cup, or a cavity.

7. The system of claim 1, wherein the mounting device and the arm are integrally formed.

8. A system for attaching a window ornament to a vehicle comprising:
a vehicle attachment device comprising:
a mounting device constructed and arranged to attach to an edge of a window; and
an arm operably coupled to the mounting device, wherein the arm includes a proximal end and a distal end, the distal end coupled to the mounting device, the proximal end positioned below a point on the edge of the window where the mounting device is attached; and
an ornament attachment device operably coupled to the vehicle attachment device and being constructed and arranged to couple to a window ornament.

9. The system of claim 8, wherein the arm defines an arm axis and the mounting device defines a mounting device axis, wherein the arm axis is positioned at an angle of less than or equal to 135 degrees with respect to the mounting device axis.

10. The system of claim 8, wherein the arm rotates with respect to the mounting device.

11. The system of claim 8, wherein the arm further comprises a slot and the ornament attachment device is disposed in the slot.

12. The system of claim 11 further comprising a retention knob constructed and arranged to secure the ornament attachment device in the slot.

13. The system of claim 11, wherein the slot is positioned at the proximal end of the arm.

14. The system of claim 8, wherein the mounting device comprises at least one of a magnet, a suction cup, or a cavity.

15. The system of claim 8, wherein the mounting device and the arm are integrally formed.

16. A system for attaching a window ornament to a vehicle comprising:
a vehicle attachment device comprising:
a mounting device constructed and arranged to attach to the vehicle, the mounting device defining a mounting device axis; and
an arm operably coupled to the mounting device, the arm defining an arm axis, the arm axis positioned at an angle of less than or equal to 135 degrees with respect to the mounting device axis; and
an ornament attachment device operably coupled to the vehicle attachment device and being constructed and arranged to couple to a window ornament.

17. The system of claim 16, wherein the arm further comprises a slot and the ornament attachment device is disposed in the slot.

18. The system of claim 16 further comprising a retention knob constructed and arranged to secure the ornament attachment device in the slot.

19. The system of claim 16, wherein the arm includes a proximal end and a distal end, the distal end is coupled to the mounting device, and the slot positioned at the proximal end.

20. The system of claim 16, wherein the arm rotates with respect to the mounting device.
